(19) United States
(12) Patent Application Publication
(10) Pub. No.: US 2026/0291124 A1
(43) Pub. Date: Sep. 24, 2026

(54) ELECTRICAL POWER JACK FOR DETACHABLE CONNECTION WITH AN ELECTRICAL POWER PLUG AND ELECTRICAL POWER COUPLING CONSISTING OF SUCH A POWER JACK AND AN ASSOCIATED ELECTRICAL POWER PLUG

(71) Applicant: Fronius International GmbH, Pettenbach (AT)

(72) Inventors: Andreas LEONHARTSBERGER, Pettenbach (AT); Thomas GSCHMEIDLER, Pettenbach (AT); Thomas FREUDENTHALER, Pettenbach (AT); Sebastian LICHT, Pettenbach (AT)

(73) Assignee: Fronius International GmbH, Pettenbach (AT)

(21) Appl. No.: 18/996,082

(22) PCT Filed: Aug. 4, 2023
(86) PCT No.: PCT/EP2023/071665

§ 371 Date: Jan. 17, 2025

(30) Foreign Application Priority Data
Aug. 5, 2022 (EP) 22188955.3

(51) Int. Cl. H01R 13/625; H01R 13/00; H01R 13/18; H01R 24/20; H01R 24/28

(52) U.S. Cl. CPC H01R 13/625; H01R 13/005; H01R 13/18; H01R 24/20; H01R 24/28

(57) ABSTRACT

An electrical power jack for detachable connection to an electrical power plug includes an electrically conductive base body with a bore for accommodating an essentially cylindrical pin of the plug and with a device for connection to a power cable. The base body has a helical groove for insertion of a locking nose of the plug. The base body includes a bushing with the helical groove and a receptacle for the bushing. An electrical power coupling has such a power jack and an associated electrical power plug. The helical groove includes at least two areas with a positive gradient, and areas with a negative gradient are arranged at the end of each area with a positive gradient to form a respective latching step. The receptacle is formed from metal or metal alloy with an electrically insulating sheath and the bushing is formed from a harder material than the receptacle.

### CROSS REFERENCE TO RELATED APPLICATIONS

This application is the National Stage of PCT/EP2023/071665 filed on Aug. 4, 2023, which claims priority under 35 U.S.C. 119 of European Application No. 22188955.3 filed on Aug. 5, 2022, the disclosure of which is incorporated by reference. The international application under PCT article 21(2) was not published in English.

### BACKGROUND OF THE INVENTION

### 1. Field of the Invention

The invention relates to an electrical power coupling comprising an electrical power jack and a corresponding electrical power plug with an essentially cylindrical pin, wherein the power jack for detachable connection to the power plug is formed, with a base body made of electrically conductive material with a bore for accommodating an essentially cylindrical pin of the power plug and with a device for connecting to a power cable, wherein a helical groove for receiving a locking nose of the power plug is arranged in the base body, wherein the base body comprises a bushing with the helical groove and a receptacle for the bushing.

### 2. Description of the Related Art

The term “essentially cylindrical” is intended to clarify that the bore in the base body of the electrical power jack as well as the pin of a matching electrical power plug can also deviate slightly from the rotationally symmetrical shape and be slightly eccentric, for example.

Electrical power jacks of this type, together with suitable electrical power plugs, constitute electrical power couplings that are designed to transmit high currents of up to several hundred amperes. For example, such electrical power couplings are used in welding systems to conduct high welding currents from the welding power source to the welding torch and the workpiece. The standard DIN EN 60974-12 “Plug connections for welding cables” exists for these connections, which are common in welding technology. However, such electrical power jacks can also be used in other applications, such as photovoltaic systems or battery chargers, as part of corresponding electrical power couplings for transmitting the direct current from solar modules or the charging current for charging batteries.

In welding systems, plugs from the company DINSE Ges.m.b.H. are very often used for power cable couplings and hose package couplings. These are known to a person skilled in the art of welding technology as DINSE® plugs, DINSE® jacks or DINSE® connectors. With the DINSE® connector, a plug with a locking nose is screwed into a jack with a helical groove with a rotational angle of approx. 270° and a gradient of around 4 mm per 360°. The thread-like interaction between plug and jack results in a certain preload force or a tightening torque of the connection or a corresponding axial force that holds the plug connection in its connected state. Depending on the current, the plugs and jacks comprise different cross-sections.

In shielding gas and plasma welding systems, the shielding gas or plasma-capable medium is also fed through corresponding channels in the center of the electrical power coupling.

The relatively high gradient of the helical groove in electrical power jacks of the prior art together with a short preload length (the length of the plug connection that extends from the current contact surface between the electrical power plug and electrical power jack and the latching nose of the electrical power plug) and a high preload surface (the surface of the electrical power jack or the pin cross-section of the electrical power plug that is loaded with a force) of the connection result in an extremely steep preload characteristic, i.e. a high gradient of the force-displacement curve of the plug connection. This leads to a situation in which the energy required to release the connection, i.e. to detach the plug from the jack, is very low and even temperature fluctuations or vibrations can cause the connection to release unintentionally. As soon as the connection has lost its preload force, the contact resistance of the electrical power coupling increases rapidly. If high currents are transmitted, this can lead to local overheating at the connection between the electrical power jack and the electrical power plug, which in turn can oxidize parts of the power cable and the electrical power coupling. An oxidized electrical power coupling in turn increases the operating temperatures, which can lead to the destruction of the plastic parts of the electrical power plug and electrical power jack, the connected power cable and the connected device, for example the welding power source. If the prescribed temperature values are significantly exceeded, injury to operating personnel cannot be ruled out, too. In addition, an increase in the contact resistance of the electrical power coupling can also have a negative effect on the respective process, for example the welding process, and can even lead to defective production.

Electrical power jacks have been further developed to improve the contact resistance of the electrical power coupling by significantly increasing the release energy or release torque of the connection by means of a spring-loaded locking nose of the plug. Such an electrical power coupling is described, for example, in WO 2016/128557 A1, whereby the electrical power plug of the electrical power coupling comprises a displaceably mounted locking pin that is held in a default position by means of a spring device. In addition to the higher construction effort and the resulting higher manufacturing costs, the disadvantage of this plug is that the construction in the center of the electrical power plug means that a bore or cavity in the axial direction for guiding a gas cannot be realized or cannot be realized easily. Finally, it is also disadvantageous that the solution complexity is located in the electrical power plug, which is usually exposed to harsher environmental conditions than the jack and is also located in the more price-sensitive part of the electrical power coupling.

DE 10 2018 007 686 A1 describes a welding power cable for connection to a welding power source, whereby the risk of torsion-induced unintentional detachment of the electrical power plug from the electrical power jack is reduced by a bayonet element with a bayonet locking mechanism.

FR 2 270 695 A1 discloses an electrical power jack of the type in question, wherein the base body comprises a bushing with the helical groove and a receptacle for the bushing.

### SUMMARY OF THE INVENTION

The object of the present invention is to create an above-mentioned electrical power jack for couplings for transmitting high currents of up to several 100 A, such as can occur in welding systems, photovoltaic systems or battery chargers, which ensures the lowest possible contact resistance and thus optimum current transfer and prevents or at least minimizes the risk of local overheating of the electrical power jack and the electrical power plug due to impermissibly high current densities. The electrical power jack should be as simple and cost-effective as possible to manufacture and also allow a shielding gas or the like to be guided in the center.

Disadvantages of known electrical power jacks should be avoided or diminished.

The object according to the invention is solved by an above-mentioned electrical power coupling, wherein the helical groove of the base body of the electrical power jack comprises at least two areas with a positive gradient, and areas with a negative gradient that are arranged at the end of each area with a positive gradient to form a respective latching step, wherein the receptacle is formed from metal or a metal alloy with a sheath of electrically insulating material and the bushing is formed from a harder material than the receptacle and than the cylindrical pin of the electrical power plug. By separating the base body into at least two parts, the bushing with the helical groove and a receptacle for the bushing, the parts can be made of different materials and further advantages can be achieved, which are described below. By providing the helical groove in the bushing of the electrical power jack with at least two areas with a positive gradient and arranging areas with a negative gradient at the end of each area with a positive gradient, the operator can be given haptic feedback when the respective latching step is reached. In addition, this allows a higher release torque to be achieved than the tightening torque, which means that the electrical power coupling can no longer be released so easily unintentionally. By providing at least two latching steps, even an already worn electrical power plug can still be securely locked in the electrical power jack by selecting the second or further latching step, i.e. after reaching the first latching step, the plug is torsioned even further in relation to the electrical power jack and then held securely in the next or next but one latching step. Due to the better resulting connection of the electrical power coupling, the contact resistance can also be reduced and the risk of destruction or impairment of the electrical power jack, the electrical power plug, the power cable or the devices connected to it as well as the risk of injury due to overheating and a negative influence on the respective process, for example welding process, can be reduced. The measures taken on the electrical power jack allow connection with conventional electrical power plugs, for example the DINSE@ plugs mentioned above, and do not require the plugs of conventional components, for example welding components, to be replaced. A further advantage of the present electrical power jack is that the space around the central axis of the electrical power jack can be kept free of structural measures, whereby a bore or cavity can easily be provided in the center of the electrical power jack, for example for guiding a shielding gas, a plasma-capable medium, a welding wire or the like. The fact that the technical features for solving the task according to the invention are arranged in the electrical power jack means that the costs required for this can be shifted from the more cost-sensitive part of the electrical power coupling, the electrical power plug, to the electrical power jack. In addition, the electrical power jack is usually located in the respective device, for example in the welding power source, and is less exposed to harsh environmental conditions than the electrical power plug. However, the necessary design measures on the electrical power jack are also relatively simple and cost-effective to implement.

If a spring element is arranged in the receptacle for the bushing of the base body of the electrical power jack for spring-mounted support of the bushing in the axial direction of the receptacle, and the spring element is formed preferably by at least a wire spring washer, particularly preferably by two wire spring washers and a spacer ring arranged between the wire spring washers, a further improvement in the connection between the electrical power jack and electrical power plug and thus a lower contact resistance of the electrical power coupling can be achieved. The spring force can further increase the release torque compared to the tightening torque of the plug connection, thus further reducing the risk of unintentional detachment of the electrical power plug from the electrical power jack.

Thermal cycles, vibrations and shocks can no longer loosen the plug connection. The contact force of the power connection and thus the contact resistance can be influenced by selecting the appropriate spring element. The spring element can be used to adjust the force effect on the contact surface in the respective latching step. A force action on the contact surface of 5 to 50 N/mm2 is preferred.

Preferably, the spring element is formed by at least one wire spring washer. Such a wire spring washer can be produced very cost-effectively using a corrugated flat wire and can be arranged in the electrical power jack in a particularly space-saving manner without the central area of the jack being required and thus being available for guiding a shielding gas or the like.

Particularly preferably, the spring element is formed by two wire spring washers and a spacer ring arranged between the wire spring washers. The spacer ring prevents the spring travel of the wire spring washers arranged on either side of it from being reduced by torsion of the wire spring washers in relation to each other and the entire spring force of the wire spring washers can therefore be utilized.

As the bushing of the electrical power jack is made of a harder material than the receptacle and the cylindrical pin of the electrical power plug, wear occurs preferably on the softer electrical power plug and not on the harder bushing of the electrical power jack.

Ideally, the bushing of the base body of the electrical power jack comprises positioning elements, in particular axial latching noses, to prevent torsion relative to the receptacle of the base body. Such positioning elements on the bushing are easy to realize and do not significantly increase the manufacturing costs.

The receptacle of the base body of the electrical power jack can consist of two connectable parts, wherein the two parts of the receptacle of the base body are preferably connectable to one another via an interference fit. This means that the electrical power jack can be assembled very quickly and easily by simply placing the necessary components, the bushing and any spring elements, at the designated points on the parts of the receptacle of the base body of the electrical power jack and then connecting the parts together. The two parts of the receptacle of the base body can preferably be connected to each other via an interference fit. Alternatively, the parts of the receptacle of the base body can also be detachably connected to each other, for example via a screw joint with a left-hand or right-hand thread.

In particular, the receptacle of the base body of the electrical power jack can be made of steel or a steel alloy or of brass or a brass alloy.

The bushing of the electrical power jack is preferably made of steel or a steel alloy. This has the advantage that wear occurs preferably on the softer electrical power plug and not on the harder bushing of the electrical power jack.

The receptacle of the base body comprises a flat front face for contacting to ensure optimum current transfer to the electrical power plug. Due to the flat design of the front face of the receptacle, a uniformly low contact resistance can be achieved over the entire contact surface. Areas on the contact surface with higher contact resistance, which can lead to local overheating due to particularly high current densities, are thus prevented. If a shielding gas or the like is fed through the electrical power jack, the area around the central axis is recessed and the front face is therefore preferably formed to be annular.

To improve the current transfer, the front face of the receptacle of the base body can comprise a coating, for example a silver coating. Zinc or gold coatings are also possible for low contact resistance. Phosphate coatings, possibly in combination with other chemical substances, protect the contact surface from corrosion.

According to a feature of the invention, the groove in the bushing of the base body of the electrical power jack extends over a rotational angle of 90° to 270°. Such rotational angles are suitable for handling the electrical power coupling.

The gradient of the areas of the groove in the bushing of the base body of the electrical power jack with a positive gradient is ideally between 1 mm and 8 mm per 360°. These values are appropriate for a suitable connection of the electrical power jack with an appropriate electrical power plug with the locking nose. The gradient of the areas of the helical groove with positive gradient does not necessarily have to be constant, but can also be graded, that is increase or decrease, for example.

The gradient of the areas of the groove in the bushing of the base body of the electrical power jack with a negative gradient to form the latching steps is between 0.1 mm and 20 mm, preferably between 1 mm and 20 mm, particularly preferably between 5 mm and 20 mm per 360°. By providing the areas with a negative gradient, the release torque can be increased even further compared to the tightening torque and the haptic feedback to the user when reaching the latching steps can be improved. As already mentioned above for the areas with a positive gradient, the gradient of the areas of the helical groove in the bushing with negative gradient can also be implemented in a graded manner.

According to a further feature of the invention, the helical groove in the bushing of the base body of the electrical power jack can also comprise areas without or without a significant gradient after the areas with a negative gradient. By grading between the areas with negative gradient and the areas without gradient, a smooth transition of these areas of the helical groove can be achieved. Such transitions can have a positive influence on the user's haptic perception.

In the simplest case, the device for connecting to a power cable can be formed by a screw joint. This constitutes a simple and cost-effective realization of the connection between power cable and electrical power jack.

If the receptacle of the base body of the electrical power jack comprises a continuous bore or the like in the axial direction for guiding a shielding gas or the like, a shielding gas or plasma-capable medium can be guided through the power current contact. Instead of a rotationally symmetrical bore, a differently shaped cavity can also be provided in the axial direction in the receptacle of the base body to guide the shielding gas or the like.

### BRIEF DESCRIPTION OF THE DRAWINGS

The present invention is explained in more detail with reference to the attached drawings. They show:

FIG. 1 an electrical power coupling consisting of an electrical power jack and an electrical power plug according to the state of the art in a disconnected state;

FIG. 2 a cross section through an electrical power coupling of the prior art according to FIG. 1 with connected electrical power plug and electrical power jack;

FIG. 3 an exploded view of an electrical power jack according to the invention;

FIG. 4A to 4D detailed views of the bushing of an embodiment of an electrical power jack;

FIG. 5 a cross section through an electrical power jack;

FIG. 6 a cross section through an electrical power coupling with the electrical power plug not yet latched into the electrical power jack;

FIG. 7 the cross section through the electrical power coupling as shown in FIG. 6 with the electrical power plug latched into the electrical power jack

FIG. 8 a force-displacement preload diagram of an electrical power coupling with an electrical power jack according to the invention compared to a electrical power coupling with a conventional electrical power jack; and

FIG. 9 the contact resistance and the power loss of an electrical power coupling with an electrical power jack according to the invention compared to electrical power couplings with conventional plug connections.

### DETAILED DESCRIPTION OF PREFERRED EMBODIMENTS

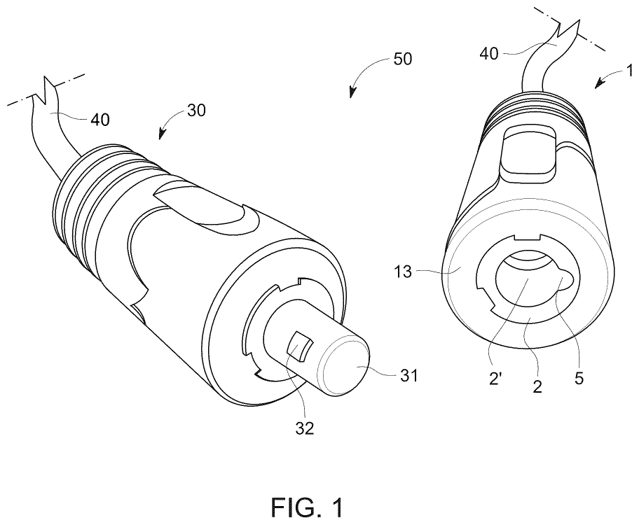

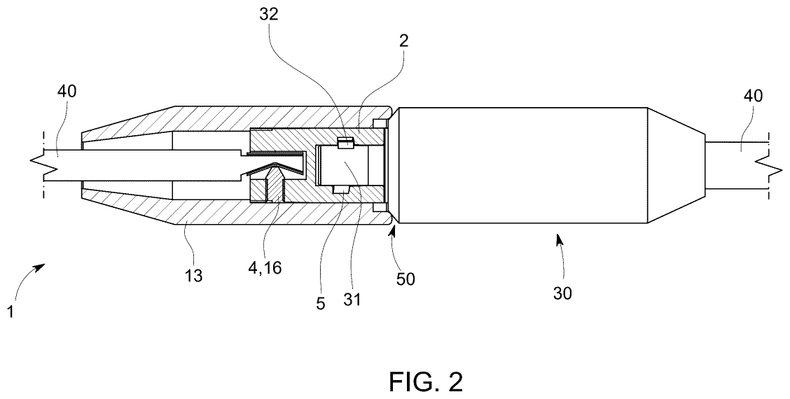

In FIG. 1, an electrical power coupling 50 consisting of an electrical power jack 1 and an electrical power plug 30 according to the state of the art is shown in a disconnected state. In addition to a base body not described in detail, a corresponding insulation and a device for connection to the power cable 40, the electrical power plug 30 comprises a essentially cylindrical pin 31 made of electrically conductive material with a locking nose 32. The electrical power jack 1 for detachable connection to the electrical power plug 30 comprises a base body 2 made of electrically conductive material with a bore 2′ for accommodating the pin 31 of the electrical power plug 30. The electrical power jack 1 also comprises a device 4 for connection to the power cable 40, for example a screw joint, which is not described in more detail (see FIG. 2). In the base body 2 of the electrical power jack 1 there is a helical groove 5 for the receptacle of the locking nose 32 of the electrical power plug 30. To connect the electrical power plug 30 to the electrical power jack 1, the essentially cylindrical pin 31 of the electrical power plug 30 is inserted into the bore 2′ of the base body 2 of the electrical power jack 1 in such a way that the locking lug 32 engages in the groove 5. The electrical power plug 30 is then torsioned relative to the electrical power jack 1 in accordance with the pathway of the helical groove 5 in the base body 2 of the electrical power jack 1 (not shown).

Nevertheless, the release torque is usually low and unintentional detachment of the electrical power plug 30 from the electrical power jack 1 of the electrical power coupling 50 is likely. The risk of loosening is increased in the event of temperature fluctuations or mechanical forces on the parts of the electrical power coupling 50. The increase in contact resistance that occurs when the connection is loosened can lead to local overheating of the electrical power plug 30, the electrical power jack 1 and/or the power cable 40 and to the destruction of parts of these components. Although the situation can be improved by a springy mounted locking lug 32, for example, unintentional detachment of the plug connection can still not be ruled out.

FIG. 2 shows a cross section through an electrical power coupling 50 of the prior art according to FIG. 1 with connected electrical power plug 30 and electrical power jack 1. Here it can be seen how the locking nose 32 on the essentially cylindrical pin 31 of the electrical power plug 30 protrudes into the helical groove 5 in the base body 2 of the electrical power jack 1. In addition, the device 4 for connection to the power cable 40 in the electrical power jack 1 can be seen in the form of a screw joint 16. The electrical power jack 1 comprises a sheath 13 made of electrically insulating material.

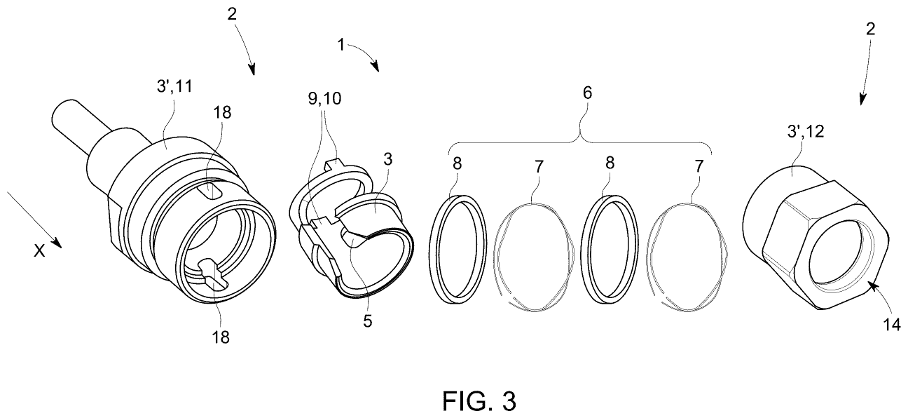

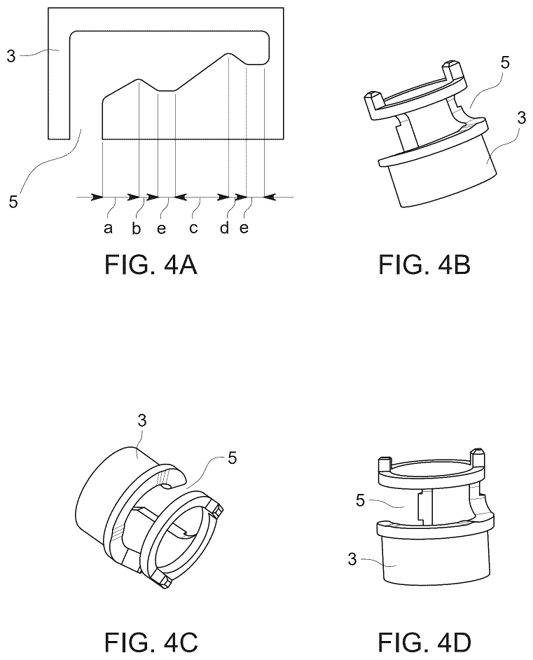

FIG. 3 shows an exploded view of an electrical power jack 1 according to the invention. The electrical power jack 1 comprises a base body 2 made of electrically conductive material with a bushing 3 with the helical groove 5 and a receptacle 3′ for the bushing 3. In the embodiment example shown, the receptacle 3′ for the bushing 3 comprises two connectable parts 11, 12. The parts 11, 12 of the receptacle 3′ of the base body 2 are made of brass or a brass alloy, for example, and comprise a sheath 13 made of electrically insulating material (not shown here). The bushing 3 is preferably made of a harder material than the receptacle 3′, for example steel or a steel alloy. The essentially cylindrical bushing 3 is used for the insertion of the essentially cylindrical pin 31 of the electrical power plug 30 (not shown). To prevent torsion of the bushing 3 relative to the receptacle 3′ of the base body 2, positioning elements 9, in particular axial latching noses 10, are arranged on the bushing 3, which protrude into corresponding recesses 18 in the part 11 of the receptacle 3′ of the base body 2. The device 4 for connection to a power cable 40, for example a screw joint 16, is not shown in detail. A helical groove 5 is arranged in the bushing 3 for accommodating the locking nose 32 of the electrical power plug 30, wherein the helical groove 5 comprises at least two areas a, c with a positive gradient, and areas b, d with a negative gradient are arranged at the end of each area a, c with a positive gradient to form a respective latching step (see FIG. 4A).

Optionally, a spring element 6 can be arranged in the base body 2 for spring-mounted support of the bushing 3 in axial direction X of the receptacle 3′ of the base body 2, which in the example shown is formed by two wire spring washers 7 and two spacer rings 8. This can increase the holding force in the locked state and thus prevent or impede unintentional detachment of the connection.

From the detailed view of the unwound lateral surface of the bushing 3 of an embodiment of an electrical power jack 1 as shown in FIG. 4A and three different views of the bushing 3 as shown in FIGS. 4B to 4D, the construction of the helical groove 5 can be better recognized. Accordingly, the helical groove 5 in the bushing 3 comprises at least two areas a, c with a positive gradient, whereby areas b, d with a negative gradient are arranged at the end of the areas a, c with a positive gradient to form a respective latching step and areas e without or without a significant gradient are arranged at the end of the areas a, c with a positive gradient, as well. Accordingly, two latching steps are realized with the bushing 3 shown. By providing the helical groove 5 in the bushing 3 of the electrical power jack 1 with at least two areas a, c with a positive gradient and arranging areas b, d with a negative gradient at the end of each area a, c with a positive gradient, the operator can be given haptic feedback when the respective latching step is reached. For a defined latching, there can be areas e without or without a significant gradient between areas a, c with a positive gradient and areas b, d with a negative gradient. However, these areas e without or without a significant gradient are not absolutely necessary. It is also possible for areas a, c with a positive gradient and areas b, d with a negative gradient to be graded, that is, their gradient is not necessarily constant but can be increasing or decreasing, for example.

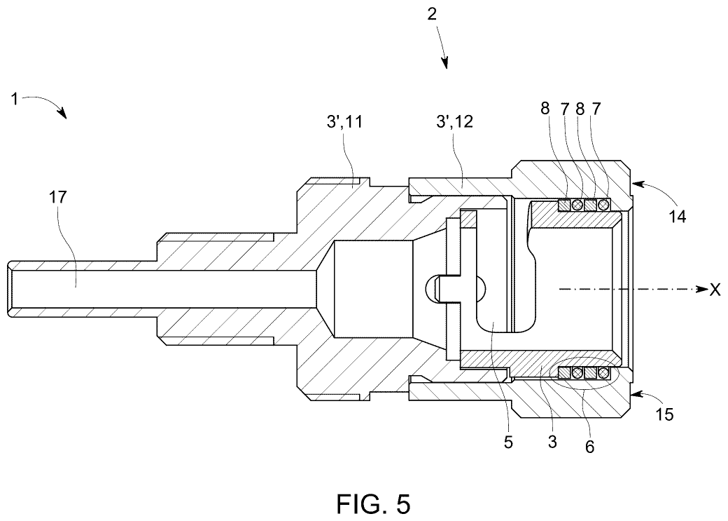

FIG. 5 shows a cross section of an electrical power jack 1 as shown in FIG. 3 in the assembled state. Accordingly, the two parts 11, 12 of the receptacle 3′ of the base body 2 of the electrical power jack 1 are connected to each other, for example by being in an interference fit. The bushing 3 is arranged inside the receptacle 3′ of the base body 2 and is mounted displaceably in axial direction X relative to the receptacle 3′ by a spring element 6 in the form of two wire spring washers 7 and two spacer rings 8. This allows an increased force to be exerted on the front face 14 of the receptacle 3′ when the electrical power jack 1 is connected to the electrical power plug 30. A coating 15, for example of silver, can be arranged on the front face 14 of the receptacle 3′ of the base body 2, which further reduces the contact resistance R_{ü}and also protects against corrosion.

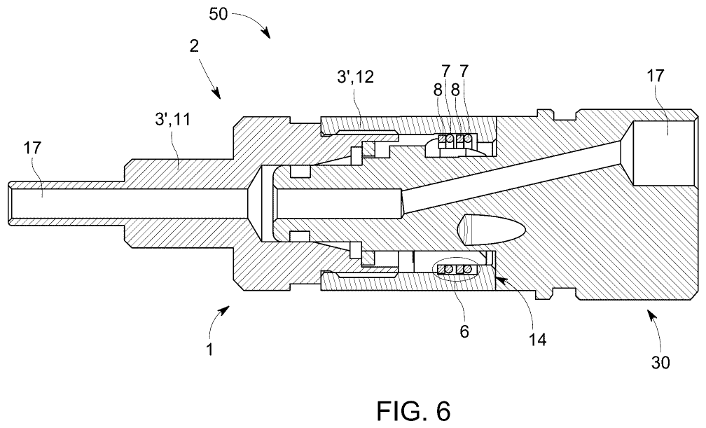

FIG. 6 shows a cross section through an electrical power coupling 50 with the electrical power plug 30 not yet latched into the electrical power jack 1. Accordingly, the two wire spring washers 7 of the spring element 6 are relaxed. In the electrical power plug 30, a continuous bore 17 for guiding a shielding gas or the like is arranged in the receptacle 3′ of the base body 2, which continues in axial direction X in the electrical power jack 1.

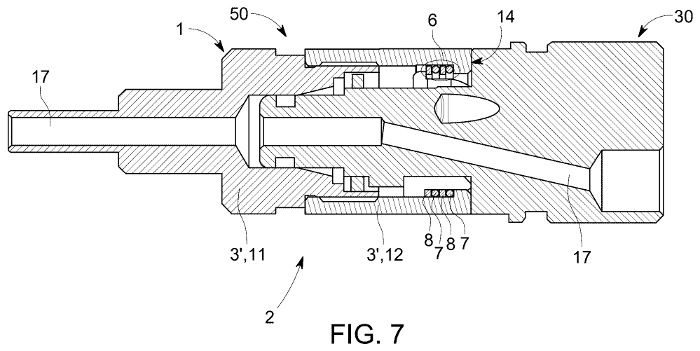

FIG. 7 shows the cross section through the electrical power coupling 50 as shown in FIG. 6 with the electrical power plug 30 latched into the electrical power jack 1. In this case, the wire spring washers 7 of the spring element 6 are compressed and the spring force is transmitted accordingly to the front face 14 of the receptacle 3′ of the base body 2 of the electrical power jack 1. As a result, the contact resistance R_{ü}of the connection of the electrical power coupling 50 can be reduced.

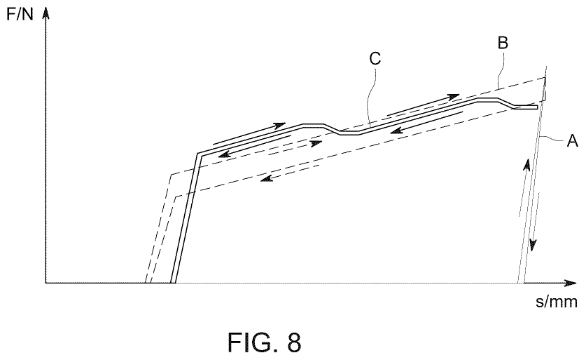

FIG. 8 shows a force-displacement preload diagram of an electrical power coupling 50 with an electrical power jack 1 designed according to the invention with two latching steps (curve C) in comparison with an electrical power coupling 50 with a conventional electrical power jack 1 (curves A and B).

The force F in N is plotted over the distance s in mm. With a conventional plug connection, for example a common DINSE® connector (curve A), the force F is very steep as a function of the distance s. The curves for closing the plug connection and opening the plug connection are essentially the same. A further development of the plug with a spring-loaded locking lug (curve B) results in a flatter curve of the force F as a function of the distance s. The curve of the force F for releasing the connection is below the curve of the force F for closing the plug connection. Accordingly, the release torque is lower than the tightening torque. The electrical power coupling 50 with an electrical power jack 1 according to the invention (curve C) results in a force-displacement curve that comprises two latching steps due to the above-described pathway of the helical groove 5 in the bushing 3 with two areas of negative gradient.

In the latched state of the plug connection, a lower force F results in each case. Accordingly, a certain force F must be overcome to open the connection or to release the electrical power plug 30 from the electrical power jack 1 according to the invention. This leads to a better hold of the plug connection, which can significantly reduce the risk of unintentional detachment of the plug connection.

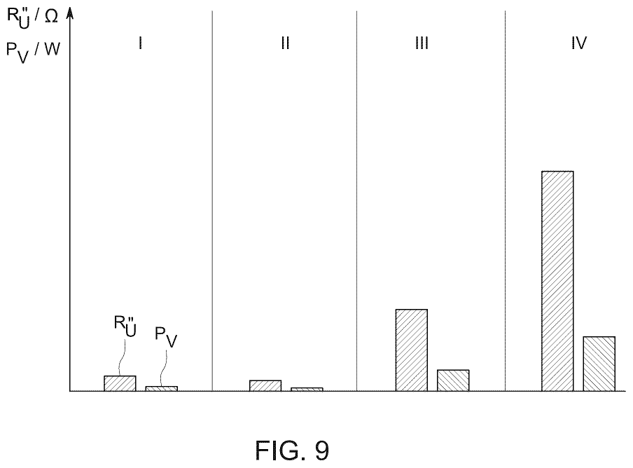

Finally, FIG. 9 shows an example of the contact resistance Ry and the power loss Pv of an electrical power coupling 50 with an electrical power jack 1 according to the invention (bar charts I) compared to electrical power couplings 50 with conventional plug connections (bar charts II to IV). The bar charts according to I show the contact resistance Ru and the power loss Pv of an electrical power coupling 50 with the electrical power jack 1 according to the invention. Both the contact resistance R_{ü}and the power loss Py comprise low values. The bar charts according to II show the contact resistance Ru and the power loss Pv for a fixed optimum connection of a conventional DINSER connector. The values for the contact resistance Ru and the power loss Pv are comparable to those of the electrical power jack 1 according to the invention according to I and are, for example, a few 10 μOhms and a few watts respectively. With a loose DINSE® connector (bar charts according to III), the contact resistance Ru and the power loss Pv increase sharply, for example to over 100 μOhms and several 10 watts respectively. The bar charts according to IV show the case of a loose DINSE® Connector, which is also oxidized. Accordingly, the contact resistance R_{ü}and the power loss Pv increase sharply, for example to several 100 μOhms and about 100 W respectively. Such values can lead to the destruction of the electrical power coupling 50 due to local overheating. In contrast, the electrical power jack 1 according to the invention ensures an optimal, stable and permanent connection with minimal contact resistance R_{ü}and minimal power loss Pv, whereby the risk of destruction of the components of the electrical power coupling 50, the power cables 40 and connected devices and the risk of injury to the user can be reduced to the greatest extent.

1-17. (canceled)

18. An electrical power coupling (50) comprising an electrical power jack (1) and an associated electrical power plug (30) with an essentially cylindrical pin (31), the electrical power jack (1) being designed for detachable connection to the electrical power plug (30), with a base body (2) made of electrically conductive material with a bore (2′) for accommodating the essentially cylindrical pin (31) of the electrical power plug (30) and with a device (4) for connection to a power cable (40), wherein a helical groove (5) for insertion of a locking nose (32) of the electrical power plug (30) is arranged in the base body (2), the base body (2) comprising a bushing (3) with the helical groove (5) and a receptacle (3′) for the bushing (3), wherein the helical groove (5) of the base body (2) of the electrical power jack (1) comprises at least two areas (a, c) with a positive gradient, and at the end of each area (a, c) with a positive gradient areas (b, d) with a negative gradient are arranged to form a respective latching step, wherein the receptacle (3′) is formed from metal or a metal alloy with an enclosure (13) of electrically insulating material and the bushing (3) is formed from a harder material than the receptacle (3′) and than the cylindrical pin (31) of the electrical power plug (30).

19. The electrical power coupling (50) according to claim 18, wherein a spring element (6) is arranged in the receptacle (3′) for the bushing (3) of the base body (2) of the electrical power jack (1) for spring-mounted support of the bushing (3) in the axial direction (X) of the receptacle (3′), and wherein the spring element (6) is preferably formed by at least one wire spring washer (7), particularly preferably by two wire spring washers (7) and a spacer ring (8) arranged between the wire spring washers (7).

20. The electrical power coupling (50) according to claim 18, wherein the bushing (3) of the base body (2) of the electrical power jack (1) comprises positioning elements (9), in particular axial latching noses (10), to prevent torsion relative to the receptacle (3′) of the base body (2).

21. The electrical power coupling (50) according to claim 18, wherein the receptacle (3′) of the base body (2) of the electrical power jack (1) comprises two parts (11, 12) which can be connected to one another, the two parts (11, 12) of the receptacle (3′) of the base body (2) preferably being connectable to one another via an interference fit.

22. The electrical power coupling (50) according to claim 18, wherein the receptacle (3′) of the base body (2) of the electrical power jack (1) is formed from steel or a steel alloy, preferably from brass or a brass alloy, and wherein the bushing (3) is formed from steel or a steel alloy.

23. The electrical power coupling (50) according to claim 18, wherein the receptacle (3′) of the base body (2) of the electrical power jack (1) comprises a flat front face (14) for contacting.

24. The electrical power coupling (50) according to claim 23, wherein the front face (14) of the receptacle (3′) of the base body (2) of the electrical power jack (1) comprises a coating (15), for example a silver coating.

25. The electrical power coupling (50) according to claim 18, wherein the groove (5) in the bushing (3) of the base body (2) of the electrical power jack (1) extends over a rotational angle (a) of 90° to 270°.

26. The electrical power coupling (50) according to claim 18, wherein the gradient of the areas (a, c) of the groove (5) in the bushing (3) of the base body (2) of the electrical power jack (1) with positive gradient is between 1 mm and 8 mm per 360°.

27. The electrical power coupling (50) according to claim 18, wherein the gradient of the areas (b, d) of the groove (5) in the bushing (3) of the base body (2) of the electrical power jack (1) with negative gradient for forming the latching steps is between 0.1 mm and 20 mm, preferably between 1 mm and 20 mm, particularly preferably between 5 mm and 20 mm per 360°.

28. The electrical power coupling (50) according to claim 18, wherein the helical groove (5) in the bushing (3) of the base body (2) of the electrical power jack (1) comprises areas (e) without gradient after the areas (b, d) with negative gradient.

29. The electrical power coupling (50) according to claim 18, wherein the device (4) for connection to a power cable (40) is formed by a screw joint (16).

30. The electrical power coupling (50) according to claim 18, wherein the receptacle (3′) of the base body (2) of the electrical power jack (1) comprises a through hole (17) or the like in axial direction (X) for guiding a shielding gas (S) or the like.
